(19) United States
(12) Patent Application Publication
(10) Pub. No.: US 2007/0087241 A1
(43) Pub. Date: Apr. 19, 2007

(54) Fuel cell power pack

(75) Inventors: Alan John Mulvenna, North Vancouver (CA); Mark Timmerman, Vancouver (CA)

Correspondence Address: GOWLING LAFLEUR HENDERSON LLP, P.O. BOX 49122, 2300-1055 DUNSMUIR ST., VANCOUVER, BC, V7X 1J1, CA

(73) Assignee: General Hydrogen Corporation

(21) Appl. No.: 11/436,594

(22) Filed: May 19, 2006

Related U.S. Application Data
(63) Continuation-in-part of application No. 11/360,486, filed on Feb. 24, 2006.
(63) Continuation-in-part of application No. 11/251,792, filed on Oct. 18, 2005.

(51) Int. Cl. H01M 8/04

(52) U.S. Cl. 429/26; 429/22

(57) ABSTRACT

A fuel cell power pack comprises a base module, a ballast module, a fuel supply module, a generator module and an enclosure consisting in part of panels, that is shaped to fit within the battery bay of an electric vehicle. The base and ballast modules are configured to provide ballast for the electric vehicle, to hold the fuel supply module, and to form part of the power pack enclosure. The fuel supply module comprises a fuel storage cylinder and a length-minimized fuel supply assembly to provide a maximized fuel supply to the generator module. The generator module comprises a fuel cell stack and balance of plant components operable to generate electricity. An explosion dissipation structure is provided on at least one enclosure panel.

### RELATED APPLICATIONS

This application is a continuation-in-part of U.S. application Ser. No. 11/360,486 “Fuel Cell Fluid Dissipater” to Robin et al., filed on Feb. 24, 2006 and U.S. application Ser. No. 11/251,792 “Fluid Management System” to Mulvenna et al., filed on Oct. 18, 2005, which are both incorporated herein by reference in their entirety and for all teachings, disclosures and purposes. This application also claims Convention Priority from Canadian application entitled “Fuel Cell Power Pack” and filed on May 10, 2006, serial number to be determined.

### TECHNICAL FIELD

The present invention relates generally to fuel cells, and in particular to a fuel cell generator and a fuel cell power pack comprising the generator.

### BACKGROUND OF THE INVENTION

Fuel cells produce electricity from an electrochemical reaction between a hydrogen-containing fuel and oxygen. One type of fuel cell is a proton-exchange-membrane (PEM) fuel cell. PEM fuel cells are typically combined into fuel cell stacks to provide a greater voltage than can be generated by a single fuel cell. The fuel used by a PEM fuel cell is typically a gaseous fuel, and the gaseous fuel is typically hydrogen, but may be another hydrogen-containing fuel, such as reformate. In a typical PEM fuel cell, a chamber of hydrogen gas is separated from a chamber of oxidant gas by a proton-conductive membrane that is impermeable to oxidant gases. The membrane is typically formed of NAFION® polymer manufactured by DuPont or some similar ion-conductive polymer. NAFION polymer is highly selectively permeable to water when exposed to gases.

A fuel cell stack can be combined with a number of balance of plant components to form an electric generator. Such balance of plant components support operation of the fuel cell stack, and include components for removing product heat, excess water and unused reactant air and hydrogen from the generator, as well as components for delivering reactants to the fuel cell stack, and for controlling fuel cell operation. The fuel cell generator can be combined with a fuel supply to form a fuel cell power pack.

Fuel cell power packs have been proposed to provide motive energy for vehicles, and to provide power for back up and auxiliary power applications. Such power packs have also been considered for retrofitting into vehicles originally designed to use another power source, such as electric industrial vehicles powered by chemical batteries. Such industrial trucks include electric lift trucks, automated guided vehicles and ground service equipment.

There are a number of challenges in retrofitting a fuel cell power pack into existing vehicles, or designing a vehicle from the outset to use a fuel cell power pack. For example, such vehicles present a packaging challenge, particularly in retrofit projects. The batteries can be removed from the electric vehicle and replaced with the power pack; however, the battery compartment in such vehicles limits the dimensions and shape of the power pack. Therefore, special consideration must be given to ensure that the power pack contains a sufficient supply of fuel and the fuel cell stack produces an output that is comparable to the batteries. Also, such battery compartments are typically not designed for the particular operating needs of a fuel cell power pack, and challenges include providing sufficient oxidant to the fuel cells, providing means for cooling the power pack, and providing measures to protect the vehicle and surroundings from the possibility of explosion caused by a hydrogen leak.

Known fuel cell generators and fuel cell power packs have not been particularly successful in providing comparable performance to batteries in electric vehicles in a safe and economical manner. In particular, there are no known fuel cell power packs that can be retrofit into a battery compartment of an existing electric vehicle that provides fuel and electrical output that result in performance comparable to the replaced batteries.

### SUMMARY OF THE INVENTION

An object of the invention is to provide an apparatus that solves at least some of the problems in the prior art. Particular objectives include providing a compact fuel cell generator or power pack that is able to supply electrical power in a cost-effective and efficient manner.

According to one aspect of the invention, there is provided an electrical generator comprising a fuel cell stack and balance of plant components arranged so that a continuous air flow path is defined in the generator that extends from an air inlet end to an air outlet end of the generator. At least some of the balance of plant components are located in the air flow path such that a sufficient air flow can be provided from the air flow path to supply reactant air to the fuel cell stack and remove heat generated by the fuel cells stack and select balance of plant components. By arranging the balance of plant- components in such a manner, the generator can produce a particularly high electrical output relative to its size, thus making the generator particularly desirable for use in applications where space is limited and high output may be desired.

According to another aspect of the invention, there is provided a fuel cell power pack comprising the above generator, a gaseous hydrogen fuel cylinder; and an enclosure comprising a volume for receiving the cylinder and an air duct spanning from an air inlet at one end of the enclosure to an air outlet at an opposed end of the enclosure. The generator is mounted in the duct such that air received by the inlet flows through the air flow path, and out of the power pack through the air outlet. By utilizing such a generator and arranging the power pack components in such a manner, the power pack can provide a particularly large fuel supply and electrical output relative to its size, thus making the power pack particularly desirable for use in applications where space is limited, and extended and high output may be desired.

The balance of plant components in the air flow path can include:
a fan effective to generate an air flow in the air flow path.
a compressor fluidly coupled to the fuel cell stack and operable to compress and deliver reactant air from the air flow path to the fuel cell stack;
a radiator thermally coupled to the fuel cell stack and operable to radiate heat from the fuel cell stack into the air flow path;
electrical components located in the air flow path such that heat generated by the electrical components are removed by the air flow; the electrical components can include at least one component selected from the group consisting of a power supply, hydrogen circulation pump, coolant circulation pump, double-layer capacitor bank, controller, contactor, fuse box, pressure reducer, and gas shut-off valve;
a fluid dissipater fluidly coupled to the fuel cell stack and located in the air flow path such that fluids in the dissipater is dissipated into the air flow; and
a hydrogen sensor and a controller communicative with the hydrogen sensor and programmed to stop operation of the generator when the hydrogen sensor detects a hydrogen concentration that exceeds a selected threshold.

The power pack can also include an air filter located in the air inlet; such an air filter is particularly useful to remove any contaminants in air that is to be used by the power pack. Also, the generator can include a double-layer capacitor bank having at least a portion thereof in the air flow path such that heat generated by the double-layer capacitor is removed by the same air flow that cools other balance of plant components.

The fuel cell power pack can be configured to fit within a battery bay of an electric vehicle. When so configured, the power pack can have a ballast module having a mass selected such that the total mass of the power pack is substantially the same as the mass of a battery designed for use in the vehicle and to be stored in the battery bay. The ballast module can form part of a support structure for receiving the fuel cylinder inside the enclosure; in such case, the support structure along with a portion of the enclosure defines the air duct.

### BRIEF DESCRIPTION OF THE DRAWINGS

FIGS. 1(a) and (b) are two perspective views of a fuel cell power pack.

FIGS. 2(a) and (b) are two perspective views of the power pack shown in FIGS. 1(a) and (b) with cover panels removed.

FIG. 3(a) and 3(b) are two perspective views of the power pack shown in FIGS. 1(a) and (b) with some cover panels and a generator removed.

FIGS. 4(a) and (b) are two perspective views of a base module of the fuel cell power pack.

FIGS. 5(a) and (b) are two perspective views of a ballast module of the fuel cell power pack.

FIGS. 6(a) and (b) are two perspective views of a fuel module of the fuel cell power pack.

FIGS. 7(a) and (b) are side elevation and end elevation views of the fuel module.

FIGS. 7(c) is an exploded perspective view of a fuel storage cylinder and fuel supply assembly of the fuel module.

FIG. 7(d) is a side elevation view of a fuel regulator of the fuel supply assembly.

FIGS. 8(a) to 8(c) are perspective views of a fuel cell generator module of the fuel cell power pack.

FIG. 8(d) is an exploded view of a fuel cell generator module of the fuel cell power pack.

FIG. 9(a) is a perspective view of a generator module with all components removed.

FIG. 9(b) is a perspective view of the generator module with certain balance of plant components removed.

FIGS. 10(a) and 10(b) are left and right side elevation views of the generator module.

FIG. 11 is a plan view of an upper cover panel of the fuel cell power pack.

FIGS. 12(a) and (b) are plan views of explosion dissipation mechanisms of the upper cover panel.

FIGS. 13(a) and (b) are perspective views of two different embodiments of the upper cover panel after dissipating the force of an explosion.

### DETAILED DESCRIPTION OF EMBODIMENTS OF THE INVENTION

According to one embodiment of the invention, a fuel cell power pack is provided that electrochemically generates electricity from compressed gaseous hydrogen and oxidant from air using a fuel cell stack. The fuel cell power pack integrates a support structure, fuel cell generator including generator balance of plant components, optional ballast, and fuel module into a single unit, and is particularly useful for mobile applications, such as providing motive power for electric vehicles. In one particular application, the fuel cell power pack can be retrofitted into battery-powered vehicles and can be mounted in the vehicle where the vehicle's battery would normally reside. However, it is within the scope of the invention to use the power pack in other applications, such as to supply electricity as a stationary power generator.

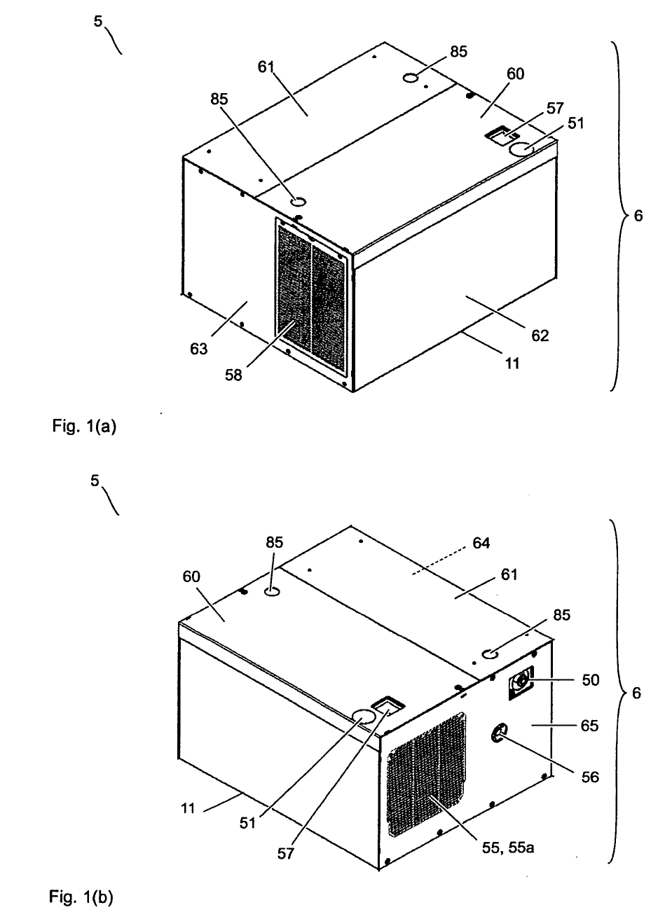

Referring to FIGS. 1(a) and 1(b), the fuel cell power pack is referenced by numeral 5 and has an enclosure 6 having a first cover 60, a second cover 61, a first panel 62, a second panel 63, a third panel 64, a fourth panel 65, and a bottom section 11. The enclosure 6 serves to house power pack components, protect these components from the outside environment, control the flow of air into and out of the power pack 5, and provide protection from explosion or fire within the enclosure 6. The first cover 60 includes an access port 51, a cable pass-through 57 and a lifting device fastening point 85. The second cover 61 includes a lifting device fastening point 85. The two lifting device fastening points 85 are provided to allow a lifting device such as a hoist (not shown) to attach to the top surface of the fuel cell power pack 5 and move the fuel cell power pack. The access port 51 is provided to allow service access to internal components. The cable pass-through 57 is provided to allow a power output cable (not shown) to pass from the interior to the exterior of the fuel cell power pack 5. The access port 51 and the cable pass-through 57 can be air-sealed for operation. The third panel 64 includes an enclosure air inlet 58 to allow air from the environment to enter the interior of the fuel cell power pack 5. The fourth panel 65 includes an enclosure air outlet 55, a fueling access cutout 50, and a fuel regulator access port 56. The enclosure air outlet 55 is provided to allow air from the interior of the fuel cell power pack 5 to reach the environment. The enclosure air outlet 55 includes a grill 55a. The fueling access cutout 50 is provided to allow access to fueling connections.

Although multiple covers are shown in this embodiment, a single cover can be substituted in place of the first cover 60, the second cover 61 and the third panel 64 within the scope of the invention. A single cover can be substituted in place of the first cover 60, the second cover 61, the first panel 62, the second panel 63, the third panel 64 and the fourth panel 65 within the scope of the invention.

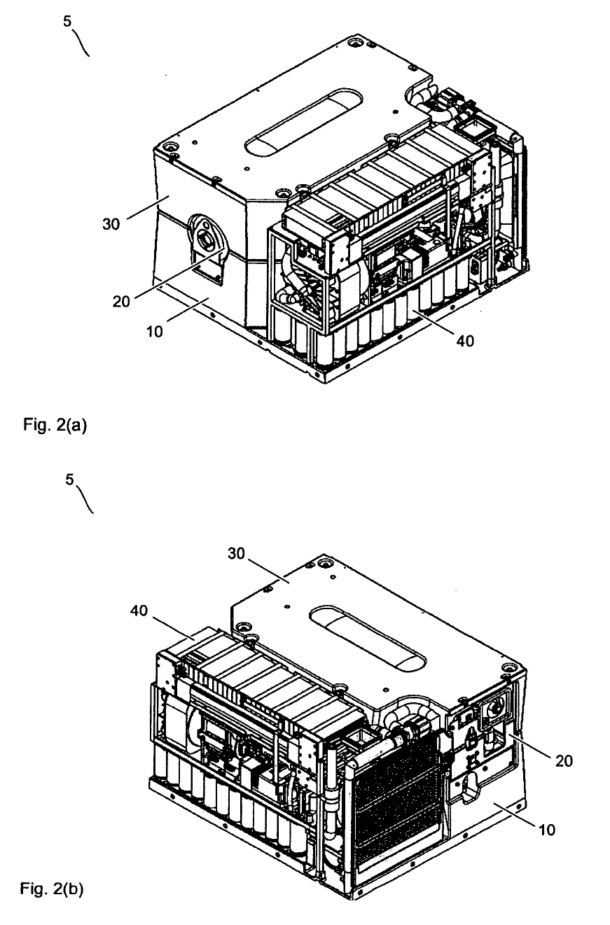

Referring to FIGS. 2(a) and 2(b), the fuel cell power pack 5 is shown with the covers and panels removed in order to illustrate internal components of the power pack. These internal components comprise a base module 10, a fuel module 20, a ballast module 30, and a generator module 40.

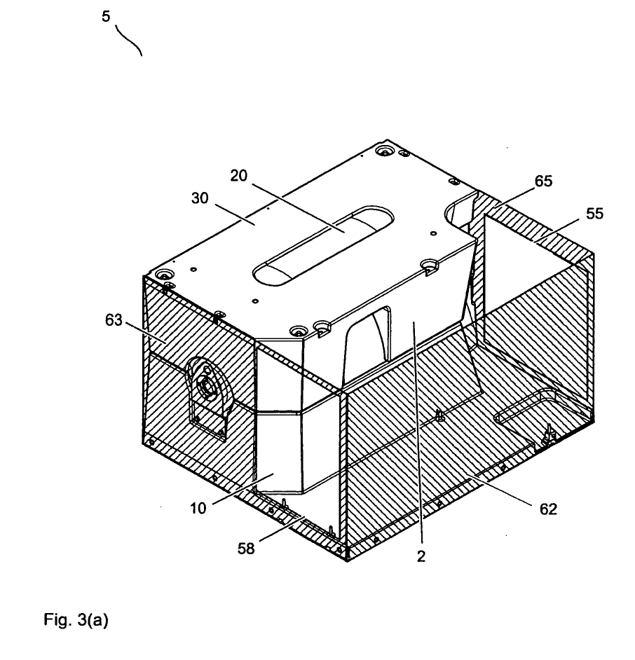

Referring to FIGS. 3(a) and 3(b), the enclosure 6 in cooperation with the base module 10, fuel module 20 and ballast module 30 define an air duct 2 inside the enclosure that extends from the enclosure air inlet 58 at a first end of the enclosure to the enclosure air outlet 55 at the opposing end of the enclosure. The generator module 40 is mounted in this air duct 2, and is designed such that air flowing through the air duct provides reactant air to fuel cells in the generator module 40, cooling air to a radiator 108 and to certain balance of plant components, removes leaked hydrogen inside the generator module 40, and removes water from the fuel cell stack through a fluid dissipater 104. An air inlet particulate filter 59 in the enclosure air inlet 58 removes particulates from the air as it enters the enclosure 6 to prevent the incursion of particulates into the interior of the enclosure. A cooling circuit fan 106 pulls air into the air duct 2 and pushes the air out of the air duct.

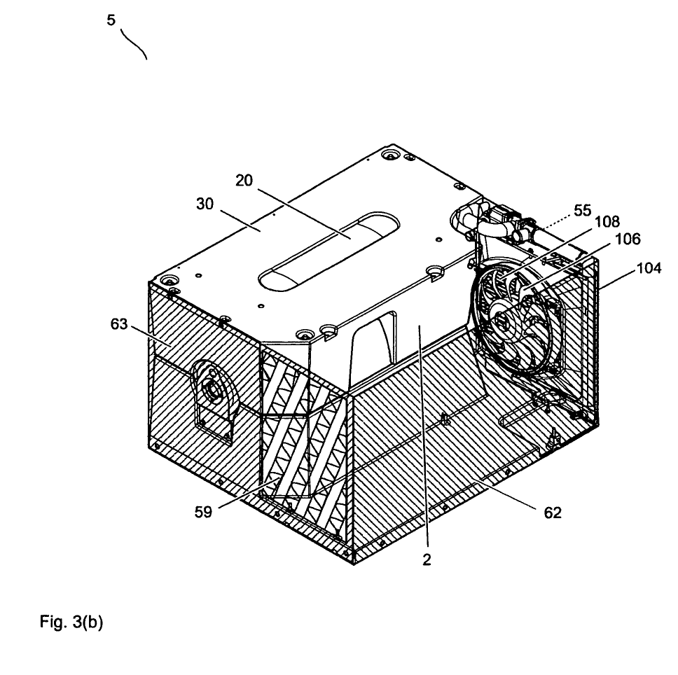

Referring to FIGS. 4(a) and 4(b), the base module 10 provides structural support for the power pack components, and base ballast. The base module 10 includes the bottom section 11 of the fuel cell power pack 5 and a top section 12. An inside surface of the top section 12 has a concave shape that conforms to the shape of the fuel module 20. Ballast positioning guides 14 extend vertically from comers of the base module 10 to allow accurate positioning of the ballast module 30. Base-to-generator fasteners 19 allow the generator module 40 to be attached to the base module 10.

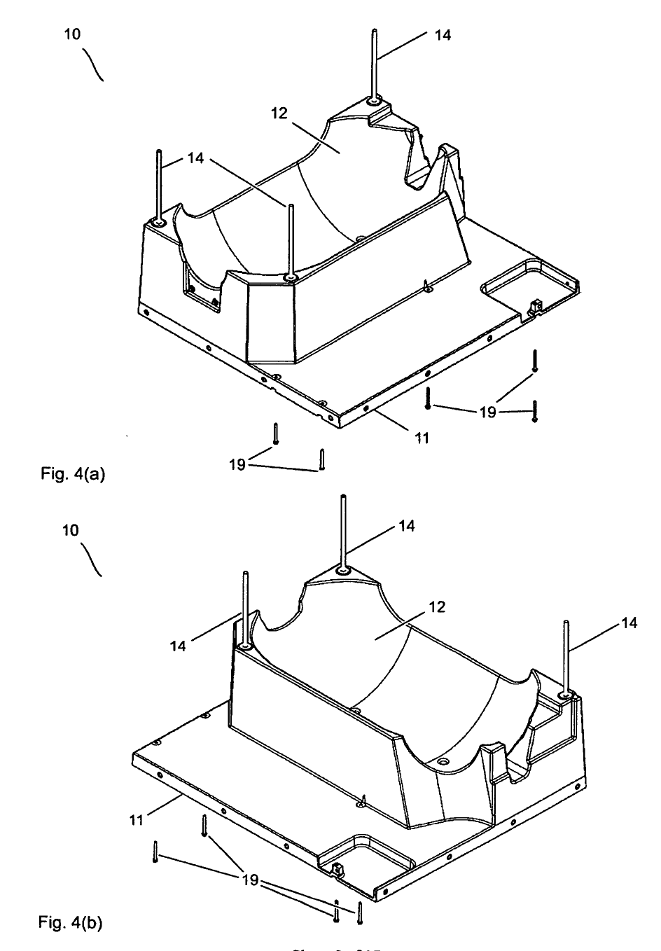

Referring to FIGS. 5(a) and 5(b), the ballast module 30 mounts over the base module 10 and the fuel module 20 to provide additional ballast. Such ballast is often required when the power pack 5 is being retrofitted into a vehicle (not shown) that was designed to be powered by other means, e.g. by batteries. In such cases, the weight and center of gravity of the power pack 5 and the original power plant sans ballast will likely differ, and the weight of the ballast can be adjusted to compensate accordingly. Where the vehicle is designed from the outset to use the power pack 5, there may be no need for ballast, and in such case, the ballast module 30 can be hollow to render it essentially weightless or omitted altogether, and the base module 10 can be hollow to render it essentially weightless.

The fuel cell power pack 5 is particularly useful for application in electric industrial trucks such as lift trucks, automated guided vehicles and ground service equipment. Conventional lift trucks that are used within enclosed environments are typically electrically powered by batteries and driven by electric motors. Such lift trucks suffer from the limited range and long recharge periods characteristic of the batteries, and are thus ideal candidates for retrofitting with the power pack 5. As is well documented in the art, fuel cell electrical generators provide significant advantages over batteries as a source of power for electric vehicles, such as substantially increased range and faster refueling periods. When the power pack 5 is intended for use in lift trucks, the weight and centre of gravity of the base module 10 and ballast module can be selected to match the battery originally designed for the lift truck.

The ballast module 30 includes ballast-to-base fasteners 31, positioning holes 33, a lower section 32, and generator fastening points 39. An inside surface of the lower section 32 has a concave shape that conforms to the shape of the fuel module 20. The ballast module 30 is accurately aligned to the base module 10 by placing the ballast module 30 such that the positioning holes 33 fit over the ballast module positioning guides 14 and allow the ballast module 30 to be lowered until its bottom surface contacts the upper surface of the base module 10. The ballast-to-base fasteners 31 fasten to the upper end of the positioning guides 14 to secure the ballast module 30 to the base module 10.

The base module 10 and the ballast module 30 are preferably cast from gray iron. Such material is inexpensive and dense, and thus is useful for providing reduced manufacturing costs and providing ballast. However, other materials and manufacturing techniques can be substituted within the scope of the invention as will be apparent to one skilled in the art.

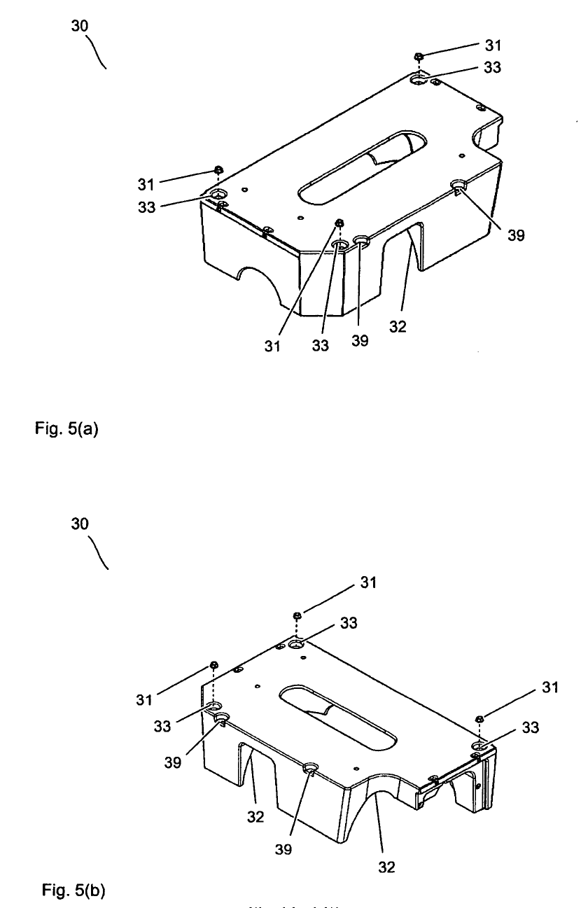

Referring to FIGS. 6(a) and 6(b), the fuel module 20 includes a fuel storage cylinder 21 that stores compressed hydrogen gas (“fuel”), mounting components for mounting the fuel module 20 to the base module 10, and a fuel supply assembly 80 for transferring fuel from the fuel storage cylinder 21 to the generator module 40. A suitable such fuel storage cylinder 21 can be a Type 4 pressure vessel rated to 700 bar manufactured by Lincoln Composites. The fuel storage cylinder 21 is generally cylindrical with semi-spherical ends; as mentioned above, the ballast module 30 and base module 10 are shaped to conform to the shape of the fuel storage cylinder 21 with air spaces therebetween. These air spaces allow the fuel storage cylinder 21 to expand in response to increases in fuel pressure. An end plug 28 is mounted to one end of the fuel storage cylinder 21 and the fuel supply assembly 80 is mounted to the other end of the fuel storage cylinder 21; the fuel storage cylinder has a fuel port (not shown) at this end which is fluidly coupled to the fuel supply assembly 80.

An end plug mounting bracket 29 is attached to the end plug 28 and serves to fasten the fuel module 20 to the base module 10. The lower end of the end plug mounting bracket 29 is attached to the base module 10, while the upper end is free to flex. The upper end of the bracket 29 is shaped to loosely contain the end plug 28 such that the fuel module 20 can be easily rotated for the purpose of installation. The flexibility of this bracket 29 also allows the fuel storage cylinder 21 to expand and contract axially, according to changes in fuel pressure. The end plug 28 can contain a temperature transducer (not shown) for sensing the internal temperature of the fuel storage cylinder 21 and transmitting the temperature value electronically by way of a signal wire (not shown) to the controller (not shown) of the generator module 40. Alternatively, the temperature transducer can be coupled to the fuel supply assembly 80.

The power pack 5 is designed to maximize the size of the fuel storage cylinder 21 within the confines of the enclosure 6; the dimensions of the enclosure are dictated by the application and are particularly limited when the fuel cell power pack 5 is retrofitted into a space originally designed for a battery. Design considerations to maximize fuel storage cylinder size include minimizing the size of the base and ballast modules 10, 30 and minimizing the air spaces between the fuel storage cylinder 21 and these modules 10, 30. Also, the length of the fuel supply assembly 80 is minimized to maximize the length of the fuel storage cylinder 21. In this description, “length” refers to the dimension parallel to the fuel storage cylinder axis, and “width” and “height” and “lateral” refer to dimensions perpendicular to the fuel storage cylinder axis.

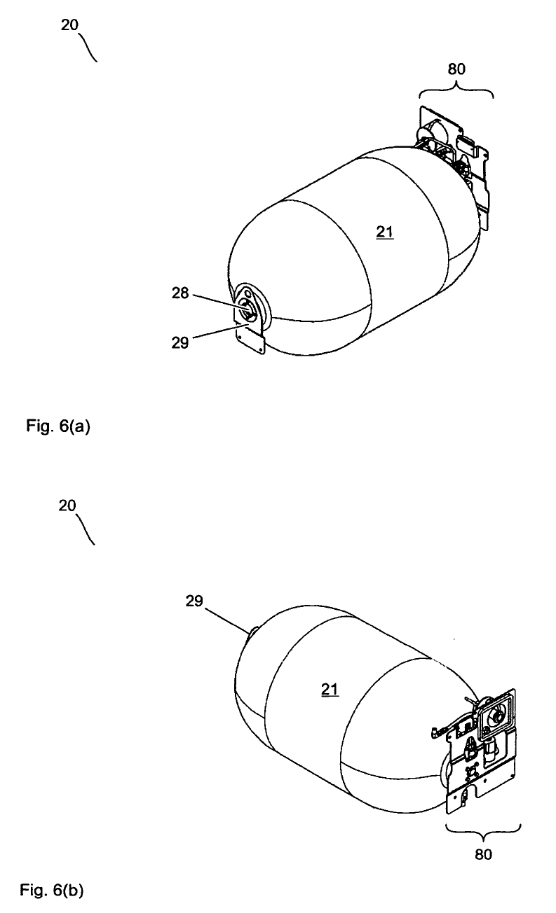

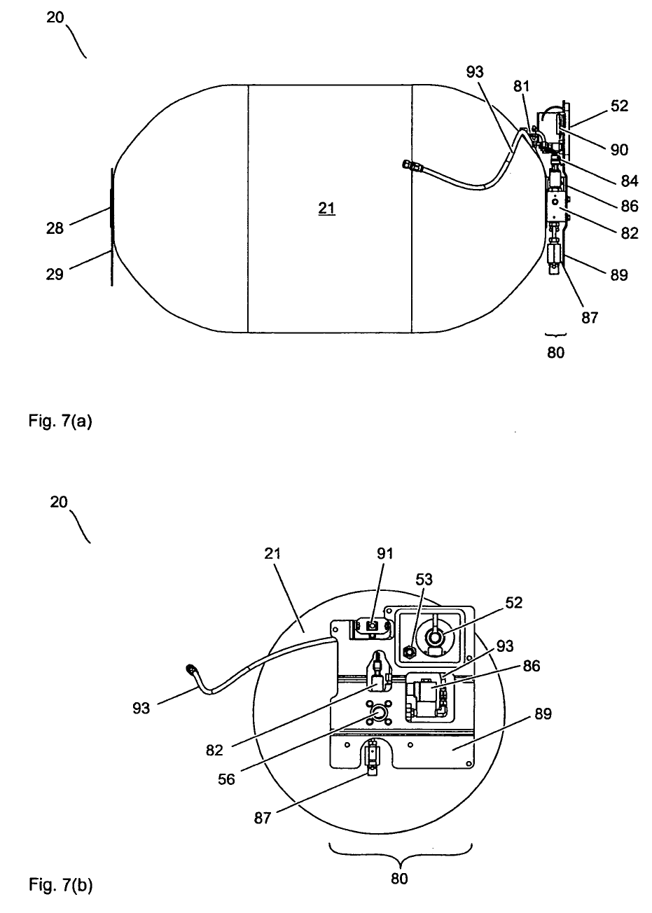

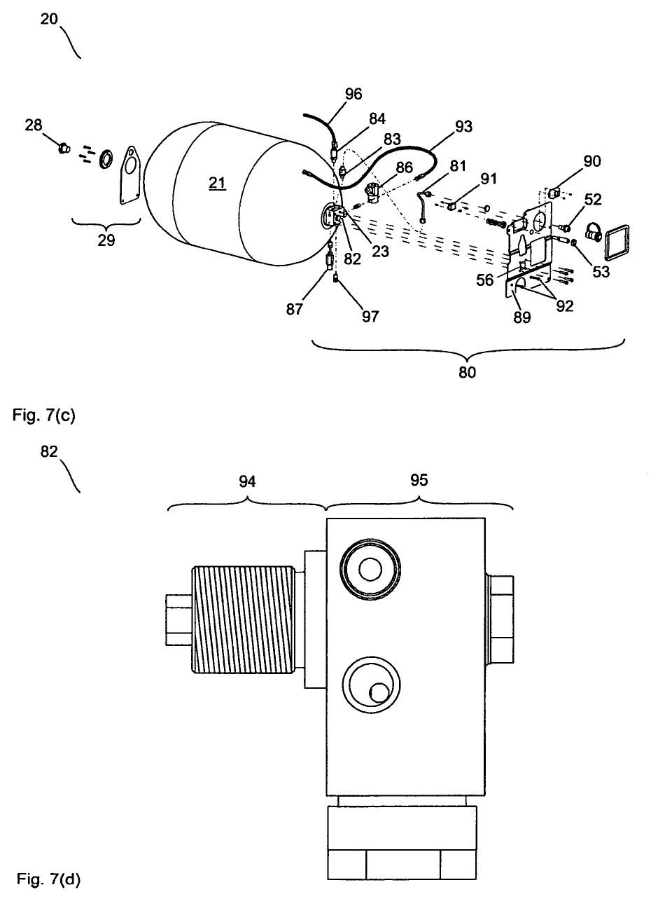

Referring to FIGS. 7(a) to 7(c), the fuel supply assembly 80 serves to fluidly couple the fuel storage cylinder 21 to the generator module 40, regulate the pressure and flow rate of the fuel supply, provide means for refueling the fuel storage cylinder 21, and provide means for detecting leaked fuel and flames. In this connection, the fuel supply assembly 80 comprises a fuel regulator 82 fluidly coupled to the fuel port (not shown) in the fuel storage cylinder 21, a check valve 83 fluidly coupled to the fuel regulator 82, a fuel filling line 81 fluidly coupled at one end to the check valve 83 and at another end to a refueling port 52. The refueling port 52 has a connector for coupling to an external fuel source (not shown) to refuel the fuel storage cylinder 21. The fuel regulator 82 also has a fuel outlet 23 that is fluidly coupled to a solenoid-operated valve 86 and a fuel transfer conduit 93. The solenoid-operated valve 86 opens and closes in response to signals from the system controller (not shown) by way of a signal wire (not shown). The fuel transfer conduit 93 is coupled to the generator module 40 and thus defines a fuel pathway from the fuel storage cylinder 21 to the fuel cells in the generator module 40.

The fuel regulator 82 and port 52 are fastened to an assembly mount 89, which in turn is fastened to the base module 10. The assembly mount 89 is also provided with a mounting hole for mounting a grounding connection 53, a hydrogen sensor 90, and a flame sensor 91. The refueling port 52 is compliant with the Society of Automatic Engineers J2600 standard for transfer of high pressure hydrogen gas. The grounding connection 53 is provided to allow a ground cable (not shown) to be interconnected between the external fuel source equipment (not shown) and the fuel cell power pack 5. A fuel regulator access port 56 is provided in the mount 89 to allow service access to the fuel regulator 82. The hydrogen sensor 90 is provided to sense the presence of leaked fuel within the fuel cell power pack 5 and to send a corresponding signal to a system controller (not shown) by way of a signal wire (not shown). The flame sensor 91 is provided to sense the presence of flames within the fuel cell power pack 5, and send a corresponding signal to the system controller (not shown) by way of a signal wire (not shown).

The fuel regulator 82 includes a built-in excess flow fuse (not shown), and a manually activated shutoff valve (not shown) as are well known for fuel regulators. Also coupled to the fuel regulator 82 are a pressure transducer 84 and a pressure transducer signal wire 96, a fuel bleed valve 97, and a pressure relief device 87. The pressure transducer 84 is provided to sense the pressure of the fuel in the fuel storage cylinder 21 and to send a corresponding signal to the system controller (not shown) by way of the pressure transducer signal wire 96. The fuel bleed valve 92 is provided to allow manual venting of fuel from the fuel storage cylinder 21. The pressure relief device 87 is provided to allow fuel to escape from the fuel storage cylinder 21 in the event of an over-pressure condition, as required by law.

In order to reduce the length of the fuel supply assembly 80 (thereby increasing the available length for the fuel storage cylinder 21) the mount 89 is designed to extend perpendicularly from the fuel storage cylinder axis, which allows the fuel supply assembly components to be mounted in a lateral direction from the fuel storage cylinder axis. Also, the fuel regulator 82, which is typically a bulky component, is designed especially to minimize its length. As can be seen in FIG. 7(d), the fuel regulator 82 has a fuel storage cylinder connector 94 and a main body 95. The fuel storage cylinder connector 94 extends axially and into the fuel storage cylinder 21, and the main body 95 is provided with laterally-mounted ports for coupling to the fuel filling line 83 and the fuel transfer conduit 93. These ports are laterally-mounted so that the fuel filling line 83 and fuel transfer conduit 93 extend laterally from the fuel storage cylinder axis, thereby minimizing the length of the fuel supply assembly 80. A suitable such fuel regulator 82 can be a fuel regulator manufactured by Tescom Corporation.

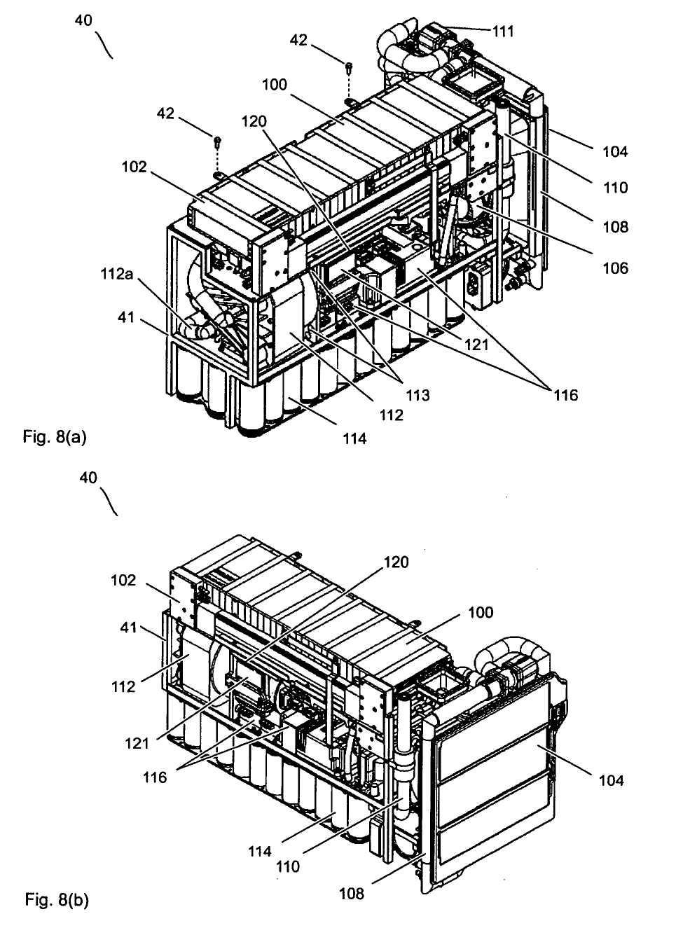

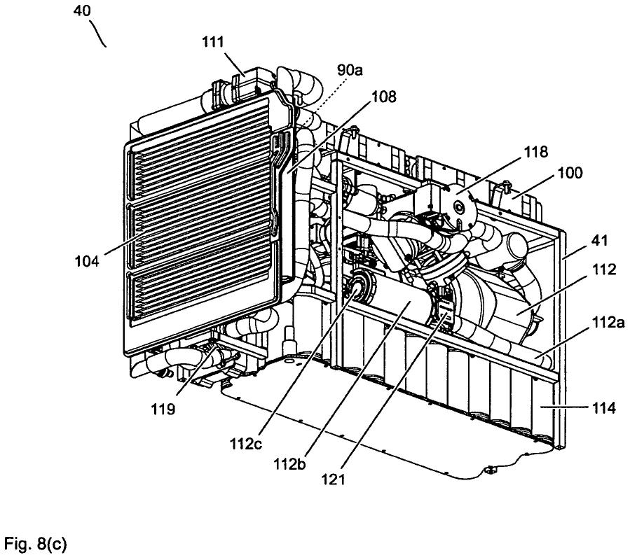

Referring now to FIGS. 8(a) to 8(d), the generator module 40 includes a generator frame 41, which is attached to the base module 10 by way of generator-to-ballast fasteners 42, and is attached to the ballast module 30 by way of the base-to-generator fasteners 19.

The generator module 40 includes a fuel cell stack 100 that electrochemically reacts gaseous hydrogen fuel supplied by the fuel storage cylinder 21 and oxygen from ambient air to produce electricity. By-products of the reaction include water and heat. The fuel cell stack 100 comprises a stack of a proton exchange membrane (PEM) type fuel cells; a suitable such fuel cell stack is the Mark 9 stack manufactured by Ballard Power Systems. However, it is within the scope of the invention for the power pack to use other types and makes of fuel cells.

The generator module 40 also includes balance of plant components for controlling and humidifying the supply of air and fuel to the fuel cell stack 100, controlling and conditioning the supply of electricity generated by the fuel cell stack, cooling the fuel cell stack, and removing excess water, unreacted fuel and air and contaminants from the fuel cell stack. Such balance of plant components include a fluid management apparatus 102, a fluid dissipater 104, a cooling circuit fan 106, a radiator 108, a coolant tank 110, an air compressor 112, an energy storage array 114, a power supply 116, a system controller 120, a subsystem controller 121, a coolant bypass valve 111, an air compressor filter 112b, an air compressor motor controller 112d, a fuel circulation pump 118, a coolant circulation pump 119, a de-ionizing filter 122, a contactor 123, a fuse box 124, a fuel pressure reducer 125, and a fuel shutoff valve 126. A plurality of air flow holes 113 in the air compressor's mounting plate provide air flow paths through the plate.

The generator frame 41 includes a top rack 44, a bottom rack 45 and a frame end 46. The fuel cell stack 100 and fluid management apparatus 102 are coupled to each other and are together mounted to the top surface of the top rack 44. The fuel circulation pump 118, system controller 120, air compressor motor controller 112d, fuel pressure reducer 125, fuel shutoff valve 126, de-ionizing filter 122 are mounted to the bottom surface of the top rack 44. The air compressor 112, air compressor filter 112b, air compressor filter inlet 112c, power supply 116, subsystem controller 121 are mounted to the top surface of the bottom rack 45. The energy storage array 114 is mounted to the bottom surface of the bottom rack 45. The coolant tank 110 and radiator 108 are mounted to the frame end 46. The cooling circuit fan 106, fluid dissipater 104 and coolant bypass valve 111 are mounted to the radiator 108.

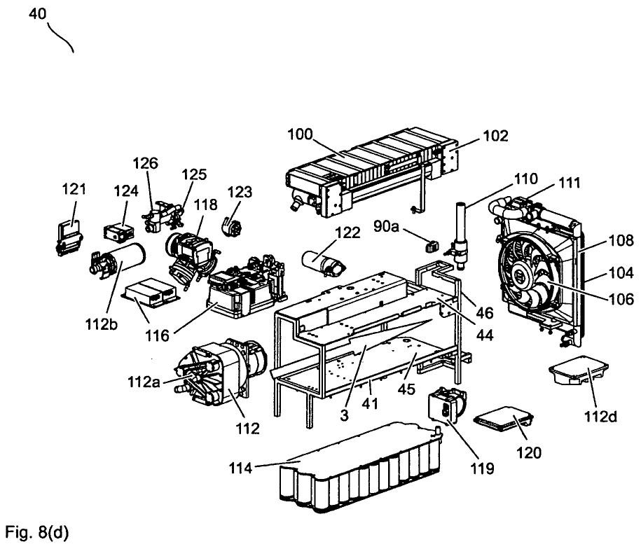

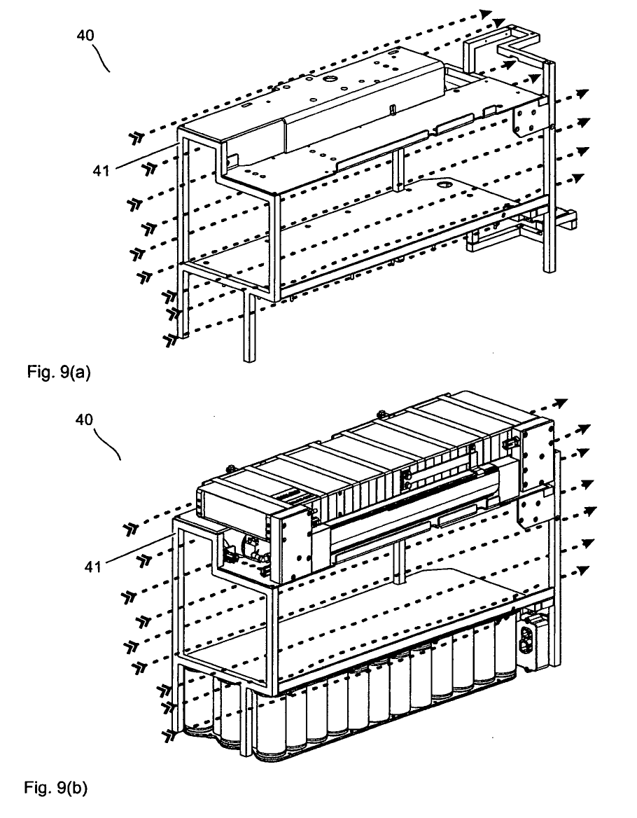

The space between the bottom surface of the top rack 44 and the top surface of the bottom rack 45 is not filled by the components mounted to the bottom surface of the top rack 44 and to the top surface of the bottom rack 45 and their interconnecting pipes, tubes, cables and wires, such that an air flow path 3 through the generator module 40 is maintained. In other words, the balance of plant components are positioned to allow sufficient air flow through the generator module 40 for supplying reactant air to fuel cells in the generator module 40, cooling air to the radiator and the balance of plant components, removal of leaked hydrogen inside the generator module 40, and removal of water from the fuel cell stack. FIGS. 9(a) and 9(b) illustrates a plurality of air flow sub-paths through the generator as denoted by dashed arrows.

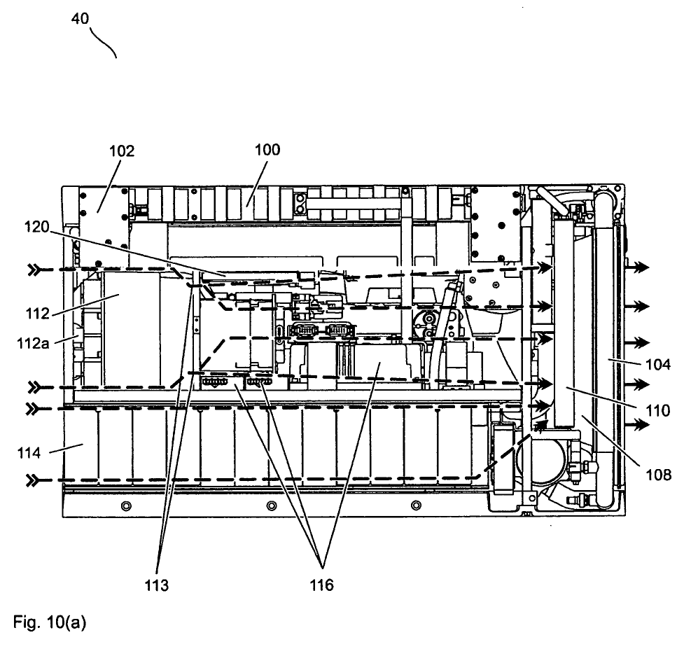

Referring now to FIGS. 10(a) and 10(b), the generator module 40 is shown to have a plurality of air flow sub-paths around and past the balance of plant components, as denoted by dashed arrows. The air flow is coolest at the enclosure air inlet 58, and increases in temperature as it flows past warmer components. The air flow provides the most cooling where it is coolest.

The air compressor 112 is provided to compress air for a reactant air circuit of the fuel cell stack 100, as is typical for PEM-type fuel cell power systems. The air compressor 112 generates large amounts of heat when operating, and can overheat and fail from overheating, unless provided with cooling. The positioning of the air compressor 112 near the enclosure air inlet 58 locates the compressor within the coolest part of the air flow path 3, such that the air flow can maintain the compressor below its maximum operating temperature. The positioning of the air compressor filter 112b and the air compressor filter inlet 112c is for convenience, and does not reflect a need for cooling. A suitable such air compressor can be a scroll-type air compressor manufactured by Air Squared under the model number P32H58W2.

The power supply 116 is provided to convert the output voltage of the fuel cell stack 100 to at least one standard voltage suitable for electric equipment, as is typical of fuel cell power systems. The power supply 116 of the current invention includes a first DC voltage regulator, a second voltage regulator and a third voltage regulator. The power supply generates heat when operating, and can overheat and fail from overheating, unless provided with cooling. The positioning of the power supply 116 within the air flow path 3, allows the air flow to maintain the power supply 116 below its maximum operating temperature. In the preferred embodiment of the invention, the first DC voltage regulator additionally includes a coolant circuit of the liquid cooling system of the fuel cell stack to provide additional cooling.

The fuel circulation pump 118 is provided to circulate hydrogen in a fuel circuit of the fuel cell stack 100, and the coolant circulation pump 119 is provided to circulate coolant in a coolant circuit of the fuel cell stack 100, as is typical for PEM-type fuel cell power systems. The fuel circulation pump 118 and the coolant circulation pump 119 generate heat when operating, and can overheat and fail from overheating, unless provided with cooling. The positioning of the pumps 118, 119 within the air flow path 3 allows the air flow to maintain the compressor below its maximum operating temperature.

The energy storage array 114 is provided to store energy generated by the fuel cell stack 100, as is typical for hybrid fuel cell power systems. In the preferred embodiment of the invention, the energy storage array 114 is a bank of double-layer capacitors. The preferred double-layer capacitor is sold by Maxwell Technologies under the brand name Boostcap and the part number BCAP2600-E270-T05; however, another capacitor could be substituted without detracting from the invention. The energy storage array 114 generates heat when operating, and can overheat and fail from overheating, unless provided with cooling. The positioning of the energy storage array 114 within the air flow path 3 allows the air flow to maintain the energy storage array 114 below its maximum operating temperature.

The radiator 108 is provided as part of the cooling circuit of the generator module 40 to radiate heat from the coolant to the environment. The radiator 108 is located near the enclosure air outlet 55 such that radiated heat is readily conveyed to the environment. A suitable such radiator can be a radiator manufactured by Modine under the part number NPD2146D3.

The cooling circuit fan 106 is provided to generate an air flow path 3 through the air flow path. The cooling circuit fan 106 is positioned near and upstream of the radiator 108 to push air through the radiator in effecting heat transfer from the radiator to the cooling air stream, and in pushing the heated air through the enclosure air outlet 55 to the environment. The positioning of the cooling circuit fan 106 near the enclosure air outlet 55 also allows the fan to pull air from the environment through the enclosure air inlet 58 and the generator module 40. In the preferred operation method of the power system, the cooling circuit fan 106 is running whenever the power system is running, and the fan speed is controlled according to the temperature of coolant at the radiator 108. A suitable such cooling circuit fan can be a fan assembly manufactured by Tripac under the part number 14-LZ310BH2A.

The fluid dissipater 104 is provided to evaporate water from the fuel cell stack 100, and to dilute and disperse unreacted fuel from the fuel cells. The positioning of the fluid dissipater 104 near and downstream of the radiator 108 locates the fluid dissipater 104 within the warmest part of the air flow path 3, such that the air flow can heat and ventilate the fluid dissipater to speed the evaporation of fuel cell water within the fluid dissipater, and speed the dilution and dispersal of unreacted fuel cell fuel within the fluid dissipater. The positioning of the fuel cell stack 100 and the fluid management apparatus 102 at the top of the generator module 40 allows water from those components to flow under gravity to the fluid dissipater 104, and coolant to flow under gravity to the radiator 108 and the coolant tank 110.

The hydrogen sensor 90a is provided to sense leaked hydrogen from hydrogen containing components within the enclosure 6. The positioning of the hydrogen sensor 90a near the cooling circuit fan 106 locates the hydrogen sensor 90a where the fan draws most of the gases from within the enclosure 6. The hydrogen sensor 90a and the hydrogen sensor 90 are communicative with the system controller 120 to provide hydrogen detection information to the system controller. When starting the power system, a hydrogen reading above a predetermined value prevents start up through controller logic in order to avoid providing an ignition source to a potentially dangerous mixture of hydrogen in air. When the power system is running, a hydrogen reading above a predetermined value causes the power system to shut down through controller logic in order to isolate the fuel source and to avoid providing an ignition source to a potentially dangerous mixture of hydrogen in air. The hydrogen sensors 90a, 90 and their signals do not affect the speed or operational state of the cooling circuit fan 106.

The system controller 120, air compressor motor controller 112d, subsystem controller 121, contactor 123, fuse box 124, fuel pressure reducer 125, and fuel shutoff valve 126 generate heat when operating. The positioning of these components within the air flow path 3 allows the air flow to maintain the components below their maximum operating temperature. A suitable such system controller can be a controller manufactured by Amp under the part number F5SB-14A624-M.

The packaging of the fuel cell stack 100, the fluid management apparatus 102, the fluid dissipater 104, the balance of plant components, and connecting pipes, tubes, cables and wires within the generator module 40 allows easy installation, removal and replacement of the generator module.

The fuel cell power pack 5 is designed so that the generator module 40 can operate to generate electricity with or without the enclosure panels in place. Operating without the enclosure panels is useful for commissioning, testing and troubleshooting purposes. However it is preferable that the panels be in place, as such panels help regulate the air flow through the generator module 40 as well as protect users from the dangers of fire or explosion.

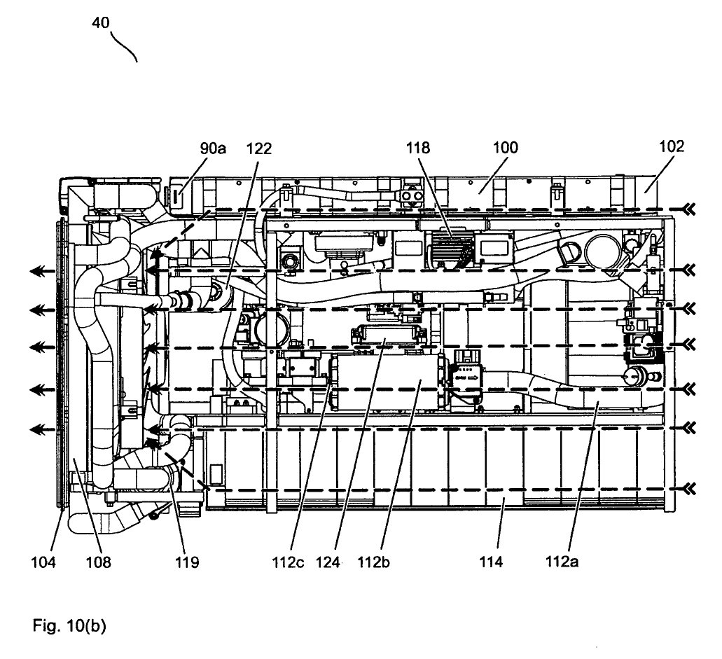

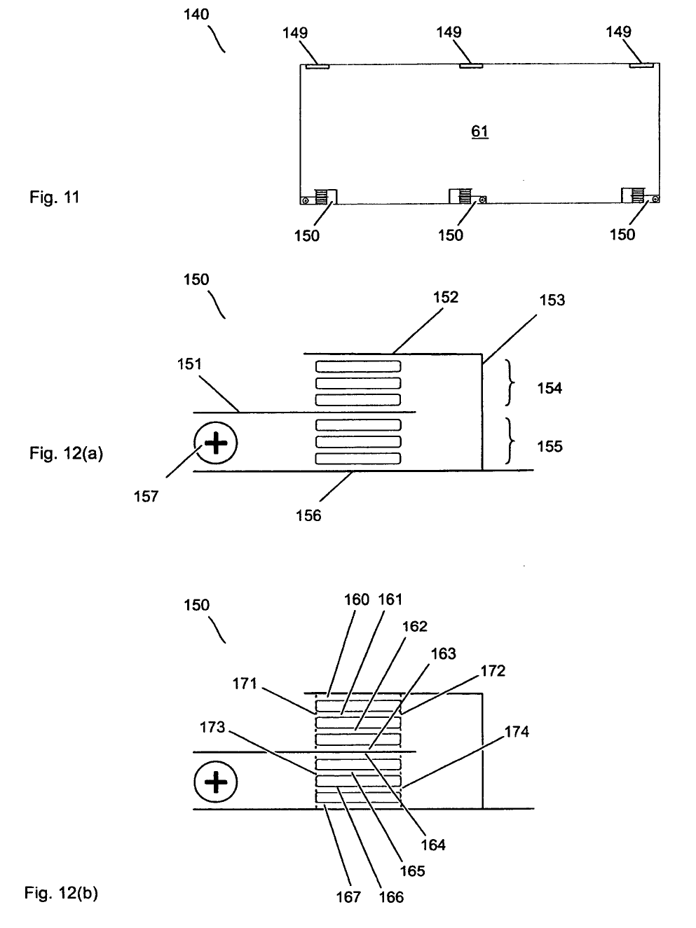

The ignition of fuel mixed with air within the enclosure 6 may cause an explosion and a sudden rise in the pressure of the gases within the enclosure. Referring to FIG. 11, the second cover 61 is provided with an explosion dissipating mechanism 140 for dissipating the effects of an explosion. The dissipating mechanism 140 consists of multiple explosion dissipating structures 150 on one edge of the second cover 61, and multiple retaining hinges 149 on the opposite edge of the cover 61. As shown in FIG. 12(a), the explosion dissipating structure comprises a cover fastener 157 and a plurality of cutouts and cuts, namely: a first cut 151, a second cut 152, a third cut 153, a first group of cutouts 154, and a second group of cutouts 155. The cuts and cutouts can be produced by laser, water jet or plasma cutting. The cover fastener 157 is provided to secure the cover 61 to the fuel cell power pack structure below. The cuts 151, 152 are parallel to each other and extend through the cover 61. The third cut 153 is perpendicular to and contiguous with the second cut 152 and extends from the second cut 152 to the cover's edge 156. The cutouts 154, 155 are rectangular openings in the cover 61, and the first group of cutouts 154 is located between the first cut 151 and the second cut 152, and the second group of cutouts 155 is located between the first cut 151 and the edge 156.

Referring to FIG. 12(b), the portions of the cover 61 that surround and interpose the first group of cutouts 154 form largely parallel lands 160, 161, 162, 163 between the first cut 152 and the second cut 153, and the portions that surround and interpose the second group of cutouts 155 form largely parallel lands 164, 165, 166, 167 between the second cut 153 and the edge 156. This alternation between cuts or cutouts and lands results in the lands being flexible in comparison with the main portion of the cover 61, and the narrow edges of the cutouts together form lines of weakness 171, 172 in the first group of cutouts 154 and lines of weakness 173, 174 in the second group of cutouts 155 that allow the explosion dissipating mechanism 150 to deflect predictably under force. The length of the cutouts 154, 155 determines the length of the portions of the explosion dissipating mechanism 140 that can deflect under force, and thereby limits the height to which the cover 61 can be raised under such force.

The optimum dimensions of the cuts, cutouts and lands, strength of the cover fastener 157, number of hinges 149, strength of the hinges 149 and hinge fasteners (not shown), and number of explosion dissipating mechanisms 150 in the explosion dissipating structure 140 are determined through calculation of the explosive force that may occur within the fuel cell power pack 5. The lands are designed to not break upon internal power pack fuel explosion, thereby preventing the cover 61 from detaching from the fuel cell power pack 5. The lands allow bending in two planes to control tension and shear force on fasteners. The lands bend to reduce force on the fastener due to internal pressure on the cover.

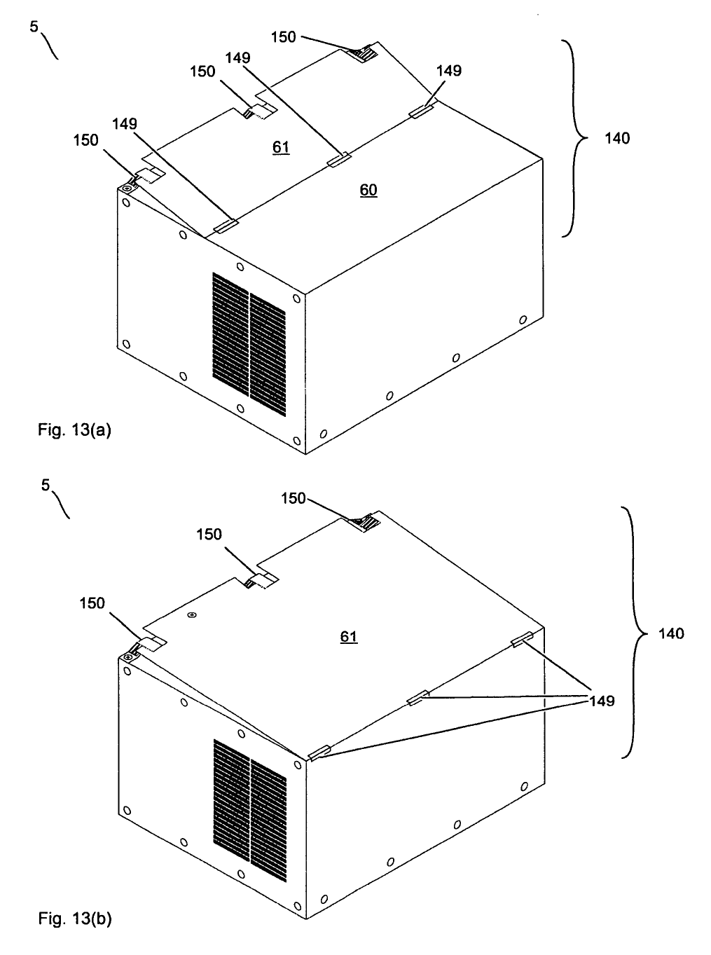

FIG. 13(a) shows the fuel cell power pack 5 with the explosion dissipation mechanisms 150 deflected and the cover 61 raised after an internal explosion. FIG. 13(b) shows an alterative embodiment of the cover 61 which covers the entire top of the power pack 5.

Assembly of the fuel module 20 includes firstly assembling the fuel supply assembly 80; and secondly attaching the fuel supply assembly 80 and the end plug 28 to the fuel storage cylinder 21. Assembly of the fuel module 20 to the base module 10 includes firstly attaching the end plug mounting bracket 29 to the base module 10; secondly positioning the fuel module 20 within the top section 12 of the base module 10 such that the end plug 28 is located within the end plug mounting bracket 29; thirdly rotating the fuel module 20 such that the assembly mount 89 fits into a mating shape of the base module 10; and fourthly attaching the fuel module 20 to the base module 10 by securing the assembly mount 89 to the base module 10 by fastening the assembly-to-base fasteners 92.

Assembly of the ballast module 30 to the base module 10 includes firstly fitting the positioning holes 33 of the ballast module 30 over the ballast positioning guide 14, secondly lowering the ballast module 30 to contact the base module 10; thirdly securing the ballast module 30 to the base module 10 by ballast-to-base fasteners 31

The generator module 40 may be assembled at any time, irrespective of the assembly of the other modules 10, 20, 30. Assembly of the generator module 40 includes fastening the fuel cell stack 100 and the balance of plant components to the generator frame 41.

Assembly of the fuel cell power pack 5 includes firstly assembling the fuel module 20 and attaching it to the base module 10 as described above; secondly, positioning and attaching the ballast module 30 to the base module 10 as described above; thirdly placing the generator module 40 on the base module 10 and attaching the generator frame 41 to the base module 10 and the ballast module 30; fourthly, coupling the fuel outlet 23 of the fuel module 20 to the fuel inlet (not shown) of the generator module 40; fifthly, coupling the transducer signal wire 96, and all other signal wires (not shown) to the system controller 120.

The attachment of the covers and panels, and passing the power output cable (not shown) from the interior of the power pack through the cable pass-through 57, together with suitable air sealing of the cable pass-through, completes the assembly of the fuel cell power pack 5.

It is to be understood that even though various embodiments and advantages of the present invention have been set forth in the foregoing description, the above disclosure is illustrative only, and changes may be made in detail, and yet remain within the broad principles of the invention. Therefore, the present invention is to be limited only by the claims appended to the patent.

What is claimed is:

1. A fuel cell power pack comprising:
(a) a gaseous hydrogen fuel cylinder;
(b) an enclosure comprising a volume for receiving the cylinder and an air duct spanning from an air inlet at one end of the enclosure to an air outlet at an opposed end of the enclosure; and
(c) an electrical generator mounted in the duct and comprising a fuel cell stack and balance of plant components arranged so that a continuous air flow path is defined in the generator that extends from the air inlet to the air outlet, and wherein at least some of the balance of plant components are located in the air flow path such that a sufficient air flow can be provided from the air flow path to supply reactant air to the fuel cell stack, and remove heat generated by the fuel cell stack and select balance of plant components.

2. A fuel cell power pack as claimed in claim 1 wherein the balance of plant components in the air flow path includes a fan effective to generate an air flow in the air flow path.

3. A fuel cell power pack as claimed in claim 2 wherein the balance of plant components in the air flow path include a compressor fluidly coupled to the fuel cell stack and operable to compress and deliver reactant air from the air flow path to the fuel cell stack.

4. A fuel cell power pack as claimed in claim 2 wherein the balance of plant components in the air flow path include a radiator thermally coupled to the fuel cell stack and operable to radiate heat from the fuel cell stack into the air flow path.

5. A fuel cell power pack as claimed in claim 2 wherein the balance of plant components further include electrical components located in the air flow path such that heat generated by the electrical components are removed by the air flow.

6. A fuel cell power pack as claimed in claim 5 wherein the electrical components include at least one component selected from the group consisting of a power supply, hydrogen circulation pump, coolant circulation pump, double-layer capacitor bank, controller, contactor, fuse box, pressure reducer, and gas shut-off valve.

7. A fuel cell power pack as claimed in claim 2 wherein the balance of plant components in the air flow path include a dissipater fluidly coupled to the fuel cell stack and located in the air flow path such that fluid in the dissipater is dissipated into the air flow.

8. A fuel cell power pack as claimed in claim 2 wherein the balance of plant components in the air flow path include a hydrogen sensor and a controller communicative with the hydrogen sensor and programmed to stop operation of the generator when the sensor detects a hydrogen concentration above a selected threshold.

9. A fuel cell power pack as claimed in claim 1 further comprising an air filter located in the air inlet.

10. A fuel cell power pack as claimed in claim 2 wherein the generator further comprises a double-layer capacitor bank having at least a portion in the air flow path such that heat generated by the double-layer capacitor is removed by the air flow.

11. A fuel cell power pack as claimed in claim 1 configured to fit within a battery bay of an electric vehicle.

12. A fuel cell power pack as claimed in claim 11 further comprising a ballast module having a mass selected such that the total mass of the power pack is substantially the same as the mass of a battery designed for use in the vehicle and to be stored in the battery bay.

13. A fuel cell power pack as claimed in claim 11 wherein the ballast module forms part of a support structure for receiving the fuel cylinder inside the enclosure, and the support structure along with a portion of the enclosure defines the air duct.

14. An electrical generator comprising
a fuel cell stack; and
balance of plant components arranged so that a continuous air flow path is defined in the generator that extends from an air inlet end to an air outlet end of the generator, and wherein at least some of the balance of plant components are located in the air flow path such that a sufficient air flow can be provided from the air flow path to supply reactant air to the fuel cell stack, and remove heat generated by the fuel cells stack and select balance of plant components.

15. A generator as claimed in claim 14 wherein the balance of plant components in the air flow path includes a fan effective to generate an air flow in the air flow path.

16. A generator as claimed in claim 15 wherein the balance of plant components in the air flow path include a compressor fluidly coupled to the fuel cell stack and operable to compress and deliver reactant air from the air flow path to the fuel cell stack.

17. A generator as claimed in claim 15 wherein the balance of plant components in the air flow path include a radiator thermally coupled to the fuel cell stack and operable to radiate heat from the fuel cell stack into the air flow path.

18. A generator as claimed in claim 15 wherein the balance of plant components further include electrical components located in the air flow path such that heat generated by the electrical components are removed by the air flow.

19. A generator as claimed in claim 15 wherein the electrical components include at least one component selected from the group consisting of a power supply, hydrogen circulation pump, coolant circulation pump, double-layer capacitor bank, controller, contactor, fuse box, pressure reducer, and gas shut-off valve.

20. A generator as claimed in claim 15 wherein the balance of plant components in the air flow path include a dissipater fluidly coupled to the fuel cell stack and located in the air flow path such that fluid in the dissipater is dissipated into the air flow.

21. A generator as claimed in claim 15 wherein the balance of plant components in the air flow path include a hydrogen sensor and a controller communicative with the hydrogen sensor and programmed to stop operation of the generator when the sensor detects a hydrogen concentration above a selected threshold.

22. A generator as claimed in claim 15 wherein the generator further comprises a double-layer capacitor bank having at least a portion in the air flow path such that heat generated by the double-layer capacitor is removed by the air flow.
